(19) United States
(12) Patent Application Publication
(10) Pub. No.: US 2026/0229677 A1
(43) Pub. Date: Aug. 6, 2026

(54) BATTERY PACK COVER

(71) Applicant: TOYOTA JIDOSHA KABUSHIKI KAISHA, Toyota-shi (JP)

(72) Inventors: Rentaro TAMURA, Nagoya-shi (JP); Hirotaka WATANABE, Toyota-shi (JP); Ryusuke KAWAGUCHI, Anjo-shi (JP)

(73) Assignee: TOYOTA JIDOSHA KABUSHIKI KAISHA, Toyota-shi (JP)

(21) Appl. No.: 19/379,780

(22) Filed: Nov. 5, 2025

(30) Foreign Application Priority Data
Feb. 4, 2025 (JP) 2025-016861

(51) Int. Cl. H01M 50/271; H01M 50/24

(52) U.S. Cl. CPC H01M 50/271; H01M 50/24

(57) ABSTRACT

A battery pack cover includes: a device cover that covers an upper surface of a battery pack including a device and a battery on the device side; a battery cover that covers the upper surface of the battery pack on the battery side and partially overlaps the device cover in an up-down direction; and a bead portion (upward protruding bead) that protrudes upward from an upper surface of an overlap portion and extends in an outward direction of a lower cover along the overlap portion.

### CROSS-REFERENCE TO RELATED APPLICATION

This application claims priority to Japanese Patent Application No. 2025-016861 filed on February 4, 2025. The disclosure of the above-identified application, including the specification, drawings, and claims, is incorporated by reference herein in its entirety.

### BACKGROUND

### Technical Field

The present disclosure relates to a battery pack cover.

### Description of Related Art

Japanese Unexamined Patent Application Publication No. 2022-92907 (JP 2022-92907 A) describes a vehicle in which a through portion is formed in the bottom surface of a waterproof tray that houses a battery pack and a cooling blower and a sheet metal bracket is disposed on the bottom surface of the waterproof tray to cover the through portion. JP 2022-92907 A describes that a seal packing is provided on the bottom surface of the waterproof tray to surround each through portion and the seal packing is sandwiched between the bottom surface of the waterproof tray and the sheet metal bracket.

### SUMMARY

In a battery pack cover that covers the upper surface of a battery pack, costs increase when a seal packing is used to suppress entry of liquid into the battery pack.

An object of the present disclosure is to provide a battery pack cover that covers the upper surface of a battery pack and suppresses entry of liquid into the battery pack while reducing costs.

A battery pack cover according to a first aspect includes: a device cover that covers an upper surface of a battery pack including a device and a battery on the device side; a battery cover that covers the upper surface of the battery pack on the battery side and

partially overlaps the device cover in an up-down direction; and a bead portion that protrudes upward from an upper surface of an overlap portion of a lower cover located relatively lower out of the device cover and the battery cover, and extends in an outward direction of the lower cover along the overlap portion.

In the battery pack cover according to the first aspect, the device cover and the battery cover partially overlap each other to form the overlap portion. One of the device cover and the battery cover that is located on the lower side of the overlap portion is the lower cover.

The upper surface of the overlap portion of the lower cover is provided with the bead portion that protrudes upward. The bead portion extends in the outward direction of the lower cover along the overlap portion. Liquid that will enter the battery pack through the overlap portion is blocked by the bead portion. Therefore, the entry of the liquid into the battery pack can be suppressed. Since there is no need to add new components such as seal packings, costs can be reduced compared to the case where new components are added.

In a battery pack cover according to a second aspect, in the first aspect, the upper surface of the overlap portion of the lower cover includes a wall portion that is provided at a position close to an upper cover located relatively higher out of the device cover and the battery cover, and is higher than a general surface provided with the bead portion.

In the battery pack cover according to the second aspect, the wall portion is provided on the upper surface of the overlap portion of the lower cover. The wall portion is located close to the upper cover located relatively higher out of the device cover and the battery cover. The wall portion is located deeper than the bead portion in the overlap portion. Therefore, the wall portion located deeper than the bead portion can further suppress the entry of liquid into the battery pack.

In a battery pack cover according to a third aspect, in the second aspect, a height of the wall portion from the general surface is greater than a height of the bead portion from the general surface.

In the battery pack cover according to the third aspect, the wall portion is higher than the bead portion. Therefore, the wall portion can block liquid that flows over the bead portion.

In a battery pack cover according to a fourth aspect, in any one of the first to third aspects, the bead portion has a recess that partially recedes downward and is partially open outward.

In the battery pack cover according to the fourth aspect, the bead portion has the recess that can further suppress the entry of liquid into the battery pack. Since the recess is partially open outward, it is possible to suppress stagnation of liquid in the recess.

According to the present disclosure, it is possible to provide the battery pack cover that covers the upper surface of the battery pack and suppresses entry of liquid into the battery pack while reducing costs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a battery pack with a battery pack cover according to a first embodiment;

FIG. 2 is a sectional view showing the battery pack cover according to the first embodiment;

FIG. 3 is a plan view partially showing the battery pack cover according to the first embodiment;

FIG. 4 is a perspective view partially showing the battery pack cover according to the first embodiment;

FIG. 5 is a sectional view showing a flow of liquid in the battery pack cover according to the first embodiment; and

FIG. 6 is a perspective view showing the flow of liquid in the battery pack cover according to the first embodiment.

### DETAILED DESCRIPTION OF EMBODIMENTS

Hereinafter, a battery pack cover according to a first embodiment of the present disclosure will be described with reference to the drawings. In the following, the scope necessary for describing the technology of the present disclosure will be mainly described, and the parts that are omitted will be considered as being based on known technologies. Identical or corresponding components in the drawings are denoted by the same or similar signs, and redundant descriptions will be omitted. When a plurality of identical or corresponding components is included in the drawings, only some of them may be denoted by the signs for clarity of illustration. Arrows F, W, and U in the drawings indicate a front-rear direction, a width direction, and an up-down direction, respectively, of a battery pack 12 with a battery pack cover 20. In the following description, unless otherwise specified, the terms "front-rear," "up-down," and "right-left" refer to front-rear in the front-rear direction of the battery pack, up-down in the up-down direction of the battery pack, and right-left in the width direction (right-left direction) of the battery pack, respectively.

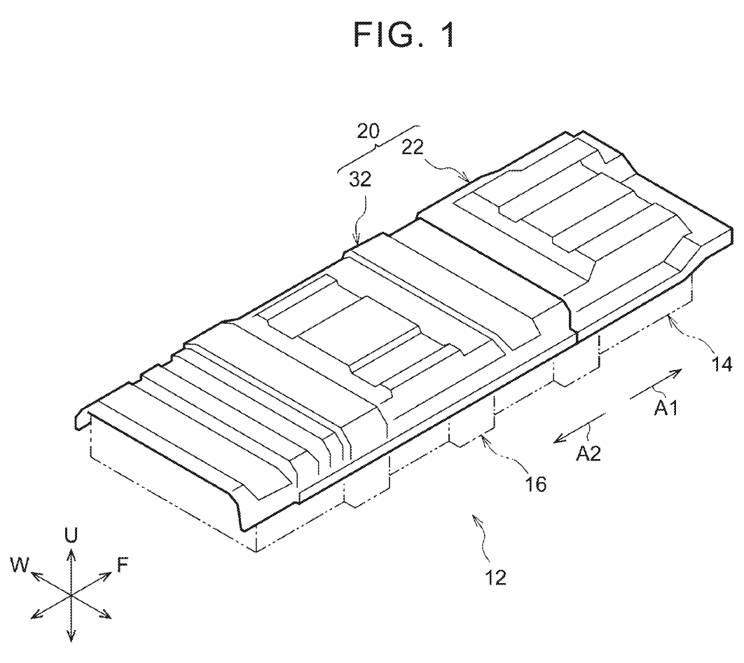

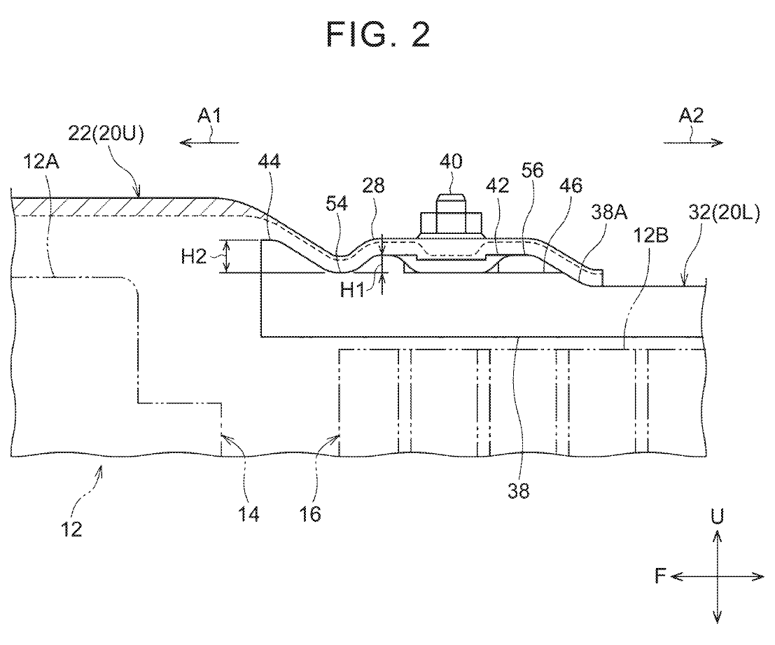

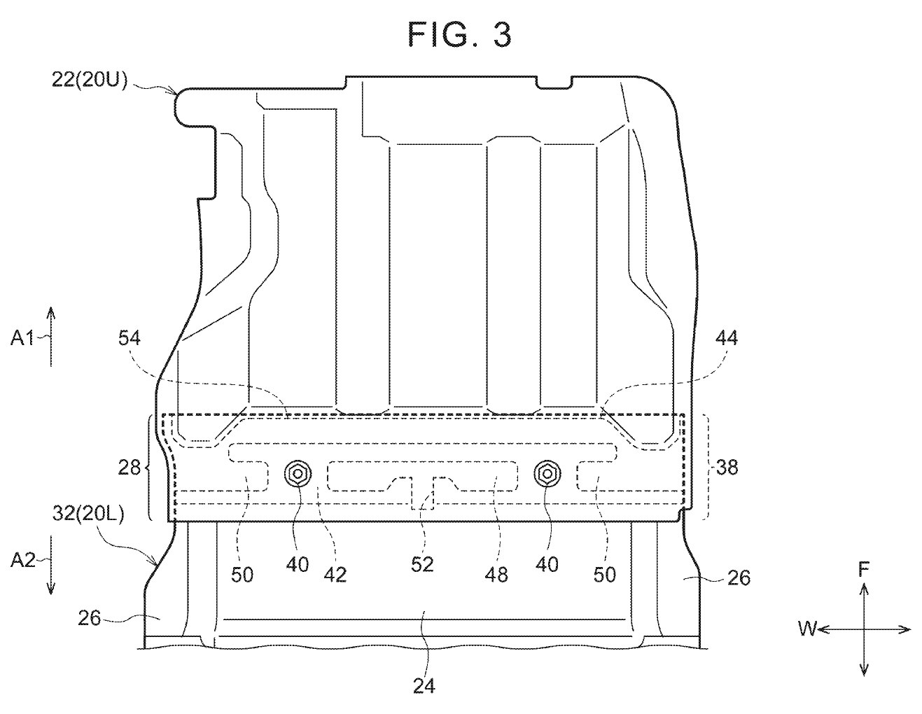

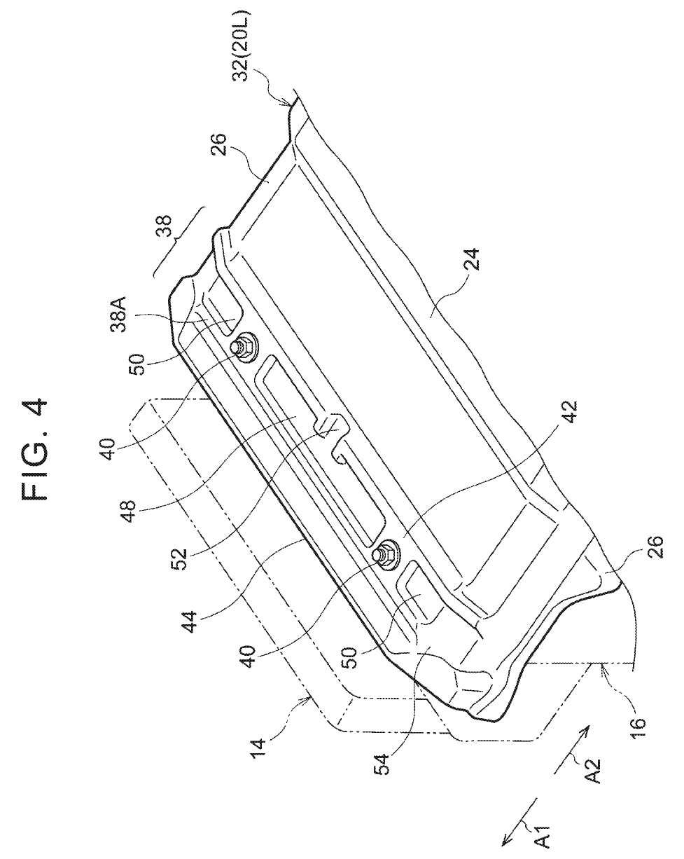

FIG. 1 is a schematic perspective view showing the battery pack 12 with the battery pack cover 20 according to the first embodiment. FIG. 2 is a vertical sectional view taken along a longitudinal direction of the battery pack 12. FIGS. 3 and 4 are a plan view and a perspective view, respectively, partially showing the battery pack cover 20.

As shown in FIG. 1, the battery pack 12 includes a device 14 and a battery 16. In the present embodiment, as shown in FIG. 2, a plurality of batteries 16 is arranged in the front-rear direction of the battery pack 12. The device 14 is located at the end of the row of the batteries 16. In the battery pack 12, the side relatively closer to the device 14 is a device side, and is indicated by arrow A1. In the battery pack 12, the side relatively closer to the batteries 16 is a battery side, and is indicated by arrow A2.

As also shown in FIG. 3, the battery pack cover 20 includes a device cover 22 and a battery cover 32.

The device cover 22 includes a device cover upper portion 24 that covers an upper surface 12A (see FIG. 2) of the battery pack 12 on the device side, and device cover side portions 26 that extend obliquely downward from both ends of the device cover upper portion 24 in the width direction.

The battery cover 32 includes a battery cover upper portion 34 and battery cover side portions 36. The battery cover upper portion 34 covers an upper surface 12B (see FIG. 2) of the battery pack 12 on the battery side. The battery cover side portions 36 extend obliquely downward from both ends of the battery cover upper portion 34 in the width direction. In the battery cover 32, a direction from the center toward the battery cover side portions 36 is an outward direction of the battery cover 32.

The device cover 22 may not only cover the upper surface 12A on the device side, but also partially cover part of the upper surface 12B of the battery pack 12 on the battery side. Similarly, the battery cover 32 may not only cover the upper surface 12B on the battery side, but also partially cover part of the upper surface 12A of the battery pack 12 on the device side.

Part of the battery cover 32, specifically part on the device side (side indicated by arrow A1), overlaps the device cover 22 in the up-down direction. A portion of the battery cover 32 that overlaps the device cover 22 is an overlap portion 38, and a portion of the device cover 22 that overlaps the battery cover 32 is an overlap portion 28. At the overlap portions 28, 38, the device cover 22 and the battery cover 32 are connected by bolts 40. In the present embodiment, the device cover 22 and the battery cover 32 are connected by two right and left bolts 40 spaced apart from each other.

In the present embodiment, the battery cover 32 is located below the device cover 22 at the overlap portions 28, 38. That is, in the present embodiment, the battery cover 32 serves as a lower cover 20L, and the device cover 22 serves as an upper cover 20U. The battery side is the lower cover side, and the device side is the upper cover side.

An upward protruding bead 42 and a wall portion 44 are provided on an upper surface 38A of the overlap portion 38 of the battery cover 32. Specifically, the upward protruding bead 42 protrudes upward from the upper surface 38A of the overlap portion 38. The upward protruding bead 42 is formed to extend along the overlap portion 38 from the battery cover upper portion 34 to the right and left battery cover side portions 36 in the outward direction of the battery cover 32. The upward protruding bead 42 is an example of a bead portion in the technology of the present disclosure.

The surface provided with the upward protruding bead 42 is a general surface 46 of the battery cover 32 (see FIG. 2). Therefore, it can be said that the upward protruding bead 42 protrudes from the general surface 46 toward the device cover 22 and extends outward in the width direction of the battery pack 12.

As shown in FIGS. 3 and 4, in a central portion in the width direction, a recess 48 is formed at a position between the two bolts 40, and part of the recess 48 is open to the battery side by a groove 52. At the ends in the width direction, recesses 50 are formed outward of the bolts 40, and each of the recesses 50 is open outward in the width direction. Therefore, the upward protruding bead 42 is formed as a three-dimensional labyrinth structure in the overlap portion 38 of the lower cover 20L (battery cover 32).

The wall portion 44 is provided on the general surface 46 of the battery cover 32 at a position closer to the device cover (side indicated by arrow A1) than the upward protruding bead 42. In the present embodiment, the wall portion 44 is formed at the end close to the device cover, and extends in the width direction. As shown in FIG. 4, a protruding height H2 of the wall portion 44 from the general surface 46 is greater than a protruding height H1 of the upward protruding bead 42 from the general surface 46. The wall portion 44 has an inclined shape that gradually increases in height toward the device side in conformity with the shape of the device cover 22.

A recess 54 that is lower in height from the general surface 46 than the upward protruding bead 42 is formed between the upward protruding bead 42 and the wall portion 44. The recess 54 extends in the width direction. Both ends of the recess 54 are open outward in the width direction.

As shown in FIG. 2, a downward protruding bead 56 that protrudes toward the battery cover 32 is formed on the device cover 22 (upper cover 20U) at a position corresponding to the upward protruding bead 42. The downward protruding bead 56 follows the upward protruding bead 42, and reduces the gap between the overlap portion 28 and the overlap portion 38 together with the upward protruding bead 42.

Next, functions of the present embodiment will be described.

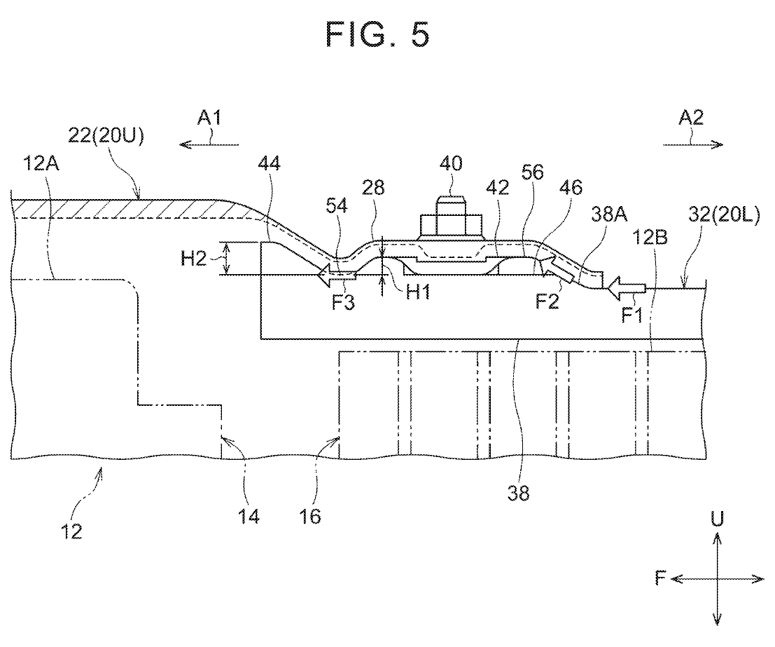

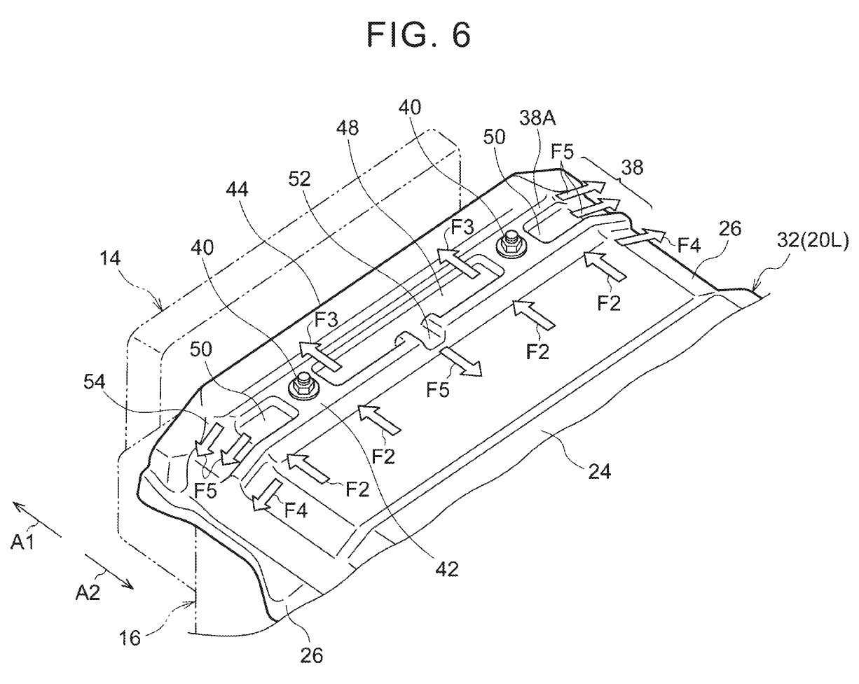

It is assumed that liquid will enter the battery pack 12 through the portion between the overlap portion 28 and the overlap portion 38 as indicated by arrow F1 in FIG. 5. In this case, as indicated by arrows F2 in FIG. 6, the liquid hits the upward protruding bead 42, and the flow to the device side is suppressed. Thus, the entry of the liquid to the device side can be suppressed. No additional components such as seal packings are required to suppress the entry of the liquid. Thus, an increase in costs can be suppressed.

The upward protruding bead 42 has the recesses 48, 50 to form the so-called labyrinth structure, which is more effective in suppressing the entry of the liquid than a structure in which the recesses 48, 50 are not formed.

The liquid that hits the upward protruding bead 42 is discharged to the outside in the width direction of the battery cover 32 as indicated by arrows F4.

Even when the liquid flows over the upward protruding bead 42, the liquid hits the wall portion 44 and is blocked as indicated by arrows F3. That is, the liquid that flows over the upward protruding bead 42 is blocked, and the entry of the liquid to the device side can be suppressed. In this can as well, no additional components such as seal packings are required to suppress the entry of the liquid. Thus, an increase in costs can be suppressed.

In particular, the height H2 of the wall portion 44 from the general surface 46 is greater than the height H1 of the upward protruding bead 42 from the general surface 46. Therefore, the effect of the wall portion 44 blocking the liquid that flows over the upward protruding bead 42 can be achieved more effectively than in a structure in which the height H2 of the wall portion 44 is equal to or smaller than the height H1 of the upward protruding bead 42.

The upward protruding bead 42 has the recesses 48, 50 to form the labyrinth structure. Therefore, it is more effective in suppressing the entry of the liquid to the device side than, for example, a simple linear bead portion.

The device cover 22 that is an example of the upper cover 20U includes the downward protruding bead 56 corresponding to the upward protruding bead 42 of the battery cover 32. The downward protruding bead 56 follows the upward protruding bead 42, and reduces the gap between the overlap portion 28 and the overlap portion 38 together with the upward protruding bead 42. Therefore, this structure is more effective in suppressing the entry of the liquid into the battery pack 12 through the gap between the overlap portion 28 and the overlap portion 38 than a structure in which the downward protruding bead 56 is not formed.

The groove 52 is formed in the recess 48, and is partially open to the battery side. The right and left recesses 50 are open outward in the width direction. The recess 54 behind (on the battery side of) the wall portion 44 is open outward in the width direction. Therefore, the liquid in the recesses 48, 50, 54 is discharged to the outside of the recesses 48, 50, 54 without stagnation as indicated by arrows F5. Since the liquid does not stagnate in the recesses 48, 50, 54, corrosion and deterioration of the battery cover 32 due to the stagnation of the liquid can be suppressed.

In the above structure, the battery cover 32 is located relatively lower in the overlap portions 28, 38 between the device cover 22 and the battery cover 32, that is, the device cover 22 is an example of the upper cover and the battery cover 32 is an example of the lower cover 20L. The up-down relationship between the device cover 22 and the battery cover 32 may be reversed, that is, the device cover 22 may be located below the battery cover 32. In this case, the battery cover 32 is an example of the upper cover, and the device cover 22 is an example of the lower cover 20L. The upward protruding bead 42 and the wall portion 44 may be provided on the upper surface of the overlap portion 28 of the device cover 22, and the downward protruding bead 56 may be provided on the lower surface of the overlap portion 38 of the battery cover 32.

The following are appendices regarding the present disclosure.

### Appendix 1

A battery pack cover including:

a device cover that covers an upper surface of a battery pack including a device and a battery on the device side;

a battery cover that covers the upper surface of the battery pack on the battery side and partially overlaps the device cover in an up-down direction; and

a bead portion that protrudes upward from an upper surface of an overlap portion of a lower cover located relatively lower out of the device cover and the battery cover, and extends in an outward direction of the lower cover along the overlap portion.

### Appendix 2

The battery pack cover according to Appendix 1, in which the upper surface of the overlap portion of the lower cover includes a wall portion that is provided at a position close to an upper cover located relatively higher out of the device cover and the battery cover, and is higher than a general surface provided with the bead portion.

### Appendix 3

The battery pack cover according to Appendix 2, in which a height of the wall portion from the general surface is greater than a height of the bead portion from the general surface.

### Appendix 4

The battery pack cover according to any one of Appendices 1 to 3, in which the bead portion has a recess that partially recedes downward and is partially open outward.

What is claimed is:

1. A battery pack cover comprising:
a device cover that covers an upper surface of a battery pack including a device and a battery on the device side;
a battery cover that covers the upper surface of the battery pack on the battery side and partially overlaps the device cover in an up-down direction; and
a bead portion that protrudes upward from an upper surface of an overlap portion of a lower cover located relatively lower out of the device cover and the battery cover, and extends in an outward direction of the lower cover along the overlap portion.

2. The battery pack cover according to claim 1, wherein the upper surface of the overlap portion of the lower cover includes a wall portion that is provided at a position close to an upper cover located relatively higher out of the device cover and the battery cover, and is higher than a general surface provided with the bead portion.

3. The battery pack cover according to claim 2, wherein a height of the wall portion from the general surface is greater than a height of the bead portion from the general surface.

4. The battery pack cover according to claim 1, wherein the bead portion has a recess that partially recedes downward and is partially open outward.
